(19) United States
(12) Patent Application Publication
(10) Pub. No.: US 2025/0052632 A1
(43) Pub. Date: Feb. 13, 2025

(54) NON-DESTRUCTIVE INSTRUMENT FOR MEASURING PRESSURE AND FLOW RATE IN A DRIPPER HOSE

(71) Applicant: Jorge Manuel ZEROLO HERNÁNDEZ, Santa Cruz de Tenerife (ES)

(72) Inventor: Jorge Manuel ZEROLO HERNÁNDEZ, Santa Cruz de Tenerife (ES)

(21) Appl. No.: 18/696,113

(22) PCT Filed: Sep. 9, 2022
(86) PCT No.: PCT/ES2022/000035

§ 371 Date: Mar. 27, 2024

(30) Foreign Application Priority Data
Sep. 29, 2021 (ES) U202100369

(51) Int. Cl. G01L 19/00; A01G 25/02; A01G 25/16; G01F 15/18

(52) U.S. Cl. CPC G01L 19/003; A01G 25/02; A01G 25/16; G01F 15/185

(57) ABSTRACT

The present invention relates to a non-destructive instrument for measuring pressure and flow rate in a dripper hose, said instrument characterised in that it has a manometric clamp that embraces the hose and connects the outlet opening of the dripper with the manometer, forming a sealed chamber due to the pressure exerted on the two arms of the clamp by way of pliers; and a graded measuring vessel, which allows the flow rate to be determined with a single hand.

### CROSS-REFERENCE TO RELATED APPLICATIONS AND PRIORITY

This patent application claims priority from International Patent Application No. PCT/ES2022/000035 filed Sep. 9, 2022, which claims priority from Sanish Patent Application No. U202100369 filed Sep. 29, 2021.

### DESCRIPTION

### Technical Field

Drip irrigation is an agricultural technique that allows water to be distributed locally. Hoses with inserted drippers, called laterals, are distributed over the ground. Drippers are emitters that, inserted in the hose, release water into the atmosphere at a very low flow rate, up to a maximum of 4.44·10⁻⁶ m³/s.

A decisive factor in irrigating efficiently is ensuring that all drippers emit a flow rate that is within the range that is determined to be the objective of the installation's hydraulic design.

This concept is reflected by the uniformity coefficient of the system (CUs) where the ideal value is 100% (all drippers emit the same flow rate).

Determining the CUs must be performed after receiving a new installation and it is advisable to maintain an annual frequency and even increase it in the event that an irregularity in crop development is observed.

The only way to calculate the CUs is by measuring the flow rates and pressures of the drippers. The following website links of interest are included to learn about the methodology.
https://www.portalfruticola.com/noticias/2016/03/04/como-medir-la-uniformidad-de-riego-en-los-cultivos/
http://scielo.sld.cu/pdf/rcta/v20n1/rcta07111.pdf

Measuring flow rate and pressure is very demanding since it must be performed on all the drippers that irrigate, for example, 16 plants in each irrigation unit.

### Background of the Invention

Two devices are currently known that are used to determine pressure.

With regard to measuring the flow rate of a dripper, only a container, a measuring cylinder and a timer are used.

A pressure gauge with a hollow needle is used to determine the pressure. The joint of these two elements must be watertight and is achieved due to a nut, where the pressure gauge is screwed, which has the end opposite to the sharp part of the needle. Together these two elements, pressure gauge and needle, proceed to take pressure readings. To do this, it is necessary to manually press until the needle completely pierces the thickness of the wall of the hose. The reading can be taken due to the fact that the water enters through the hollow in the needle until it reaches the pressure gauge that will give the pressure value at the point of the perforation. When the needle is removed, an opening remains that needs to be plugged.

The other alternative for measuring pressure is to place a manometric socket at the point where the reading is to be taken. This element is pinned into the hose and remains permanently placed. By inserting the needle of the pressure gauge through the opening in the manometric socket, the opening of an elastic closure is forced, allowing the body of the needle to pass into the hose. Once the reading is finished, the needle is removed and the elastic closure returns to its rest position, preventing water from exiting through the opening in the manometric socket.

To determine the flow rate, a timer is simultaneously activated and a container is placed under the dripper. It should be monitored to ensure that all the water falls into the same. Droplets frequently run through the hose and end up outside the container, which means the test must be restarted. To avoid this, the hose must be held with both hands, forming a valley so that the droplets leave the hose at the lowest point, where the container will be placed. To complete the recording, the timer is simultaneously stopped and the vessel is removed. The volume of water is measured using a graduated measuring cylinder or by weight, having previously tared the container. The flow rate is derived from the ratio of collected volume/elapsed time.

### DESCRIPTION OF THE INVENTION

The invention consists of an instrument made up of two elements, a manometric clamp and a graduated measuring vessel. The manometric clamp makes it possible to create a sealed chamber on the dripper hose, chamber into which a dripper pours water.

The manometric clamp is made up of two arms by way of pliers, that press the irrigation hose against an O-ring that surrounds the opening in a dripper. The chamber is defined in one of the parts and has a connection for a pressure gauge that makes it possible to know the pressure of the hose once the pressure stabilises. The chamber has another outlet that connects with a flexible microtube to the graduated measuring vessel. A converging slit in the upper portion of the graduated measuring vessel resolves the holding of the microtube to ensure the emptying into the vessel.

Additionally, it has a spike at the base of the graduated measuring vessel to ensure that it can be driven into the ground. The volume of the vessel is marked on the inside in increments of 0.00005 m³ up to 0.0002 m³.

This instrument achieves three objectives:
1. In a single procedure, pressure and flow rate of the dripper are measured.
   To measure the pressure on the dripper, the microtube is clamped by hand to pressurise the sealed chamber and be able to read the pressure gauge when it is stabilised.
   To determine the flow rate, the microtube is opened and it is attached to the measuring vessel with one hand while the other hand starts the timer.
2. This makes it possible to take measurements at any point on the hose where there is a dripper.
3. It is non-destructive since there is no need to pierce the dripper hose.

The physical foundation of the invention consists of cancelling the outlet speed of the water through the dripper and thereby cancelling the pressure loss between the water entering the dripper and its outlet.

The tight closure generates an increase in pressure in the chamber as it fills with the water exiting the dripper until the internal pressure of the hose is reached.

In this pressure balance, the water stops circulating, its speed is zero, and therefore the pressure loss is cancelled. The pressure reading reflected by the pressure gauge will be equal to that of the water circulating through the hose at that point.

The graduated measuring vessel is designed to facilitate flow rate measurement. After reading the pressure, the flexible microtube is opened, and with it the chamber exits to the atmosphere.

The water is directed through the microtube to the measuring vessel. The vessel is designed to be operated with one hand, since it is necessary to use a timer simultaneously. To do this, it has a quick coupling to hold the microtube to the vessel and a spike to drive it into the ground to avoid accidental spills.

### BRIEF DESCRIPTION OF THE DRAWINGS

To complement the description that is being made and in order to help make the features of the invention more readily understandable, a set of drawings is attached as an integral part of said description wherein, for illustrative and non-limiting purposes, the following has been represented:

FIG. 1 shows a perspective view of the manometric clamp.

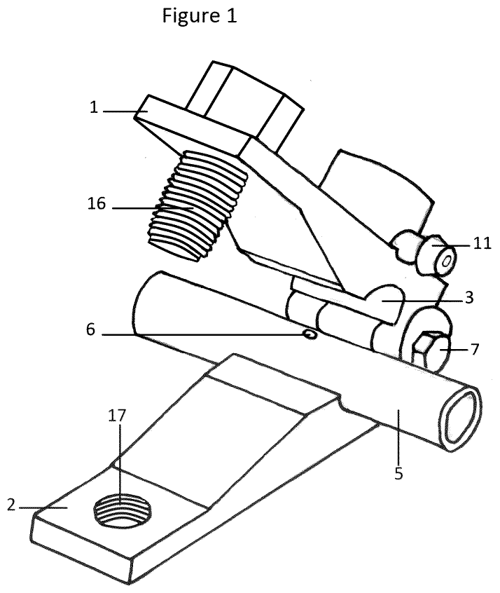

FIG. 2 shows a plan view of the manometric clamp.

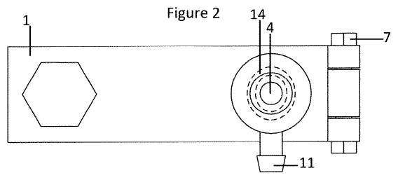

FIG. 3 shows a side view of the manometric clamp.

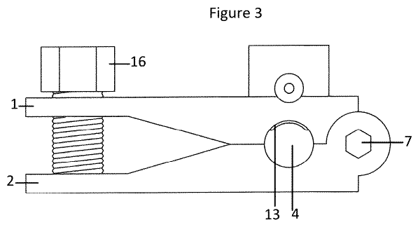

FIG. 4a shows a centred longitudinal section of the manometric clamp.

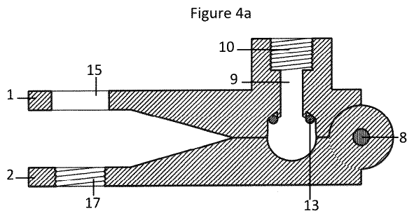

FIG. 4b shows a cross section centred with respect to the O-ring of the manometric clamp.

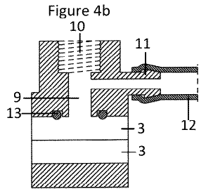

FIG. 5 shows a side view of the graduated measuring vessel.

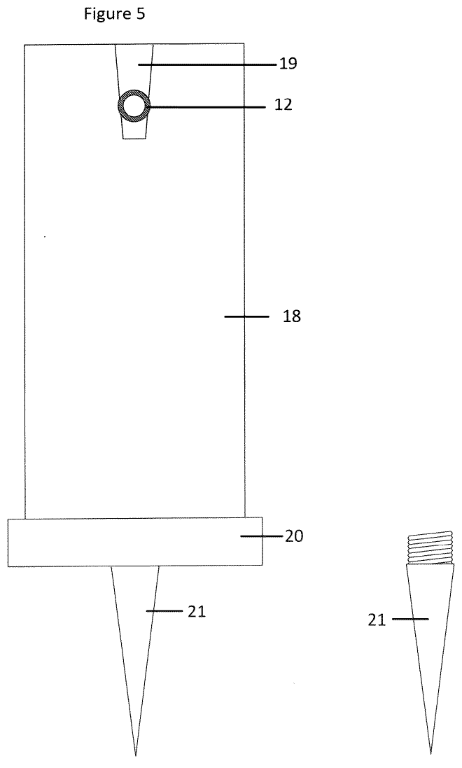

FIG. 5a shows a top view of the graduated measuring vessel.

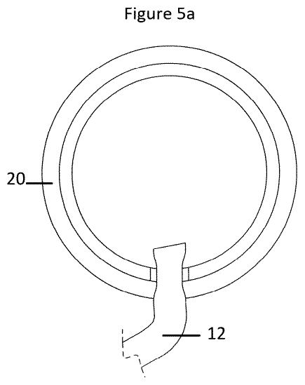

### PREFERRED EMBODIMENT OF THE INVENTION

As an example, a practical embodiment of the non-destructive instrument for measuring pressure and flow rate in a dripper hose, object of this application is represented.

In a possible embodiment, the non-destructive instrument for measuring pressure and flow rate in a dripper hose will be manufactured with appropriate materials for its elements and components, in plastic, PETG or metal material. The pin (7) is a galvanised screw, closed with a safety nut. The O-ring (13) is made of rubber, having good results with a thickness of 0.0026 m and an outer diameter of 0.016 m. The microtube (12) is made of flexible PVC with an inner diameter of 0.007 m and an outer diameter of 0.01 m, with a length of 1 m being sufficient.

1. (canceled)

2. (canceled)

3. (canceled)

4. A non-destructive instrument for measuring pressure and flow rate in a dripper hose, comprising:
a manometric clamp made up of a rigid upper part and a rigid lower part linked to one end by a pin inserted into an axis of rotation of both parts that allows the opening of both parts in order to insert the hose therebetween,
each of the parts incorporating an elliptical semicylindrical cavity in such a way that, when the upper part is arranged in contact with the lower part, they define a hollow therebetween with an elliptical cylindrical configuration intended to firmly embrace a section of the hose in which a dripper is centered with an opening facing upwards,
in which the upper part comprises a chamber that is connected:
through the cavity with the opening of the dripper,
with an upper thread in which a pressure gauge attaches.

5. The instrument of claim 4, additionally comprising a screw provided with a stem and a head, and
wherein the upper part additionally comprises, at one end opposite to the axis of rotation, an opening sized to allow the passage of the stem of the screw and not allow the passage of the head of the screw, and
wherein the lower part additionally comprises a thread to introduce the stem of the screw to maintain the pressure exerted on the hose in a stable manner, thus freeing the operator's hands.

6. The instrument of claim 4, wherein the upper part has a groove in the cavity that houses an O-ring which ensures the sealing of the chamber with the wall of the hose.

7. The instrument of claim 4, wherein the chamber is additionally connected with a side connection intended to attach a flexible tube.

8. The instrument of claim 7, additionally comprising a graduated measuring vessel comprising a container connected to the manometric clamp through the flexible tube.

9. The instrument of claim 8, wherein the container incorporates a converging slit open in the wall of the upper portion thereof through which the free end of the flexible microtube which is thus trapped in said converging slit is introduced.

10. The instrument of claim 8, wherein the vessel has a base and a thread centered on the lower external face of the base where the end of a spike can be screwed which allows the spike to be driven into the ground to gain stability against overturning.
